(19) United States
(12) Patent Application Publication
(10) Pub. No.: US 2022/0344700 A1
(43) Pub. Date: Oct. 27, 2022

(54) METHODS FOR FORMING IONICALLY CONDUCTIVE POLYMER COMPOSITE INTERLAYERS IN SOLID-STATE BATTERIES

(71) Applicant: GM GLOBAL TECHNOLOGY OPERATIONS LLC, Detroit, MI (US)

(72) Inventors: Xingcheng XIAO, Troy, MI (US); Mengyuan CHEN, Madison Heights, MI (US)

(73) Assignee: GM GLOBAL TECHNOLOGY OPERATIONS LLC, Detroit, MI (US)

(21) Appl. No.: 17/230,788

(22) Filed: Apr. 14, 2021

(51) Int. Cl. H01M 10/0562; H01M 4/36; H01M 4/38; H01M 4/62; H01M 4/583; H01M 4/04

(52) U.S. Cl. CPC H01M 10/0562; H01M 4/362; H01M 4/382; H01M 4/623; H01M 4/583; H01M 4/0471

(57) ABSTRACT

The present disclosure provides a method for forming an ionically conductive polymer composite interlayer. The method may include forming a precursor layer between a first surface of an electroactive material layer and a first surface of a solid-state electrolyte layer and converting the precursor layer to the ionically conductive polymer composite interlayer. The at least one of the electroactive material layer or solid-state electrolyte may include lithium. The first surface of the electroactive material layer and the first surface of the solid-state electrolyte layer may be substantially parallel. The precursor layer may include one or more fluoropolymers comprising carbon and fluorine. The ionically conductive polymer composite layer may have an ionic conductivity greater than or equal to about 1.0×10⁻⁸ S·cm⁻¹ to less than or equal to about 1.0 S·cm⁻¹ and may include a lithium fluoride embedded in a carbonaceous matrix.

### GOVERNMENT FUNDING

This invention was made with government support under Agreement No. DE-EE-0008863 awarded by the Department of Energy. The Government may have certain rights in the invention.

### INTRODUCTION

This section provides background information related to the present disclosure which is not necessarily prior art.

Electrochemical energy storage devices, such as lithium-ion batteries, can be used in a variety of products, including automotive products such as start-stop systems (e.g., 12V start-stop systems), battery-assisted systems (“μBAS”), Hybrid Electric Vehicles (“HEVs”), and Electric Vehicles (“EVs”). Typical lithium-ion batteries include two electrodes and an electrolyte component and/or separator. One of the two electrodes can serve as a positive electrode or cathode, and the other electrode can serve as a negative electrode or anode. Lithium-ion batteries may also include various terminal and packaging materials. Rechargeable lithium-ion batteries operate by reversibly passing lithium ions back and forth between the negative electrode and the positive electrode. For example, lithium ions may move from the positive electrode to the negative electrode during charging of the battery and in the opposite direction when discharging the battery. A separator and/or electrolyte may be disposed between the negative and positive electrodes. The electrolyte is suitable for conducting lithium ions between the electrodes and, like the two electrodes, may be in a solid form, a liquid form, or a solid-liquid hybrid form. In the instances of solid-state batteries, which includes a solid-state electrolyte layer disposed between the solid-state electrodes, the solid-state electrolyte physically separates the solid-state electrodes so that a distinct separator is not required.

Solid-state batteries have advantages over batteries that include a separator and a liquid electrolyte. These advantages can include a longer shelf life with lower self-discharge, simpler thermal management, a reduced need for packaging, and the ability to operate within a wider temperature window. For example, solid-state electrolytes are generally non-volatile and non-flammable, so as to allow cells to be cycled under harsher conditions without experiencing diminished potential or thermal runaway, which can potentially occur with the use of liquid electrolytes. However, solid-state batteries generally experience comparatively low power capabilities. For example, such low power capabilities may be a result of interfacial resistance within the solid-state electrodes and/or at the electrode and solid-state electrolyte layer interfacial resistance caused by limited contact, or void spaces, between the solid-state electroactive particles and/or the solid-state electrolyte particles; or reactions between the solid-state electrodes and the solid-state electrolyte layer. Accordingly, it would be desirable to develop high-performance solid-state battery designs, materials, and methods that improve power capabilities, as well as energy density.

### SUMMARY

This section provides a general summary of the disclosure, and is not a comprehensive disclosure of its full scope or all of its features.

The present disclosure relates to an ionically conductive polymer composite interlayer for use in solid-state batteries, and methods of forming the same.

In various aspects, the present disclosure provides a method for forming an ionically conductive polymer composite interlayer. The method may include forming a precursor layer between a first surface of an electroactive material layer and a first surface of a solid-state electrolyte layer and converting the precursor layer to the ionically conductive polymer composite interlayer. The at least one of the electroactive material layer or solid-state electrolyte may include lithium. The first surface of the electroactive material layer and the first surface of the solid-state electrolyte layer may be substantially parallel. The precursor layer may include one or more fluoropolymers comprising carbon and fluorine. The ionically conductive polymer composite layer may have an ionic conductivity greater than or equal to about 1.0×10⁻⁸ S·cm⁻¹ to less than or equal to about 1.0 S·cm⁻¹ and may include a lithium fluoride embedded in a carbonaceous matrix.

In one aspect, converting the precursor layer to the ionically conductive polymer composite interlayer may include applying pressure to the precursor layer.

In one aspect, the electroactive material layer may include lithium metal and the applied pressure may be greater than a yield strength of the lithium metal.

In one aspect, the applied pressure may be greater than or equal to about 0.5 MPa and the pressure may be applied for a period greater than or equal to about 1 minute to less than or equal to about 10 hours.

In one aspect, converting the precursor layer to the ionically conductive polymer composite interlayer may include applying heat to the precursor layer.

In one aspect, the applied heat may be greater than or equal to about 80° C. to less than or equal to about 180° C.

In one aspect, the one or more fluoropolymers may be selected from the group consisting of: polyvinylfluoride (PVF), polyvinylidene fluoride (PVDF), polytetrafluoroethylene (PTFE), polychlorotrifluoroethylene (PCTFE), perfluoroalkoxy polymer (PFA/MFA), fluorinated ethylene-propylene (FEP), polyethylenetetrafluoroethylene (ETFE), polyethylenechlorotrifluoroethyl ene (ECTFE), perfluorinated elastomer (FFPM/FFKM), tetrafluoroethylene-propylene (FEPM), perfluoropolyether (PEPE), perfluorosulfonic acid (PFSA), and combinations thereof.

In one aspect, the precursor layer may have a thickness of greater than or equal to about 5 nm to less than or equal to about 5 μm.

In one aspect, the solid-state electrolyte layer may be flexible. The solid-state electrolyte layer may have a Young's modulus of less than or equal to about 20 GPa.

In various aspects, the present disclosure provides another method for forming an ionically conductive polymer composite interlayer. The method may include disposing a precursor layer on or adjacent to a surface of an electroactive material layer, where the electroactive material layer includes lithium metal and the precursor layer includes one or more fluoropolymers comprising carbon and fluorine. The method may further include disposing a solid-state electrolyte layer on or adjacent to an exposed surface of the precursor layer, and applying at least one of pressure and heat to the precursor layer so to form the ionically conductive polymer composite interlayer disposed between the solid electrolyte layer and the electroactive material layer. The ionically conductive polymer composite layer may have an ionic conductivity greater than or equal to about 1.0×10⁻⁸ S·cm⁻¹ to less than or equal to about 1.0 S·cm⁻¹ and may include lithium fluoride embedded in a carbonaceous matrix.

In one aspect, the applied pressure may be greater than the yield strength of the lithium metal.

In one aspect, the applied pressure may be greater than or equal to about 0.5 MPa and the pressure may be applied for a period of greater than or equal to about 1 minute to less than or equal to about 10 hours.

In one aspect, the applied heat may be greater than or equal to about 80° C. to less than or equal to about 180° C.

In one aspect, the one or more fluoropolymers may be selected from the group consisting of: polyvinylfluoride (PVF), polyvinylidene fluoride (PVDF), polytetrafluoroethylene (PTFE), polychlorotrifluoroethylene (PCTFE), perfluoroalkoxy polymer (PFA/MFA), fluorinated ethylene-propylene (FEP), polyethylenetetrafluoroethylene (ETFE), polyethylenechlorotrifluoroethylene (ECTFE), perfluorinated elastomer (FFPM/FFKM), tetrafluoroethylene-propylene (FEPM), perfluoropolyether (PEPE), perfluorosulfonic acid (PFSA), and combinations thereof

In one aspect, the precursor layer may have a thickness of greater than or equal to about 5 nm to less than or equal to about 5 μm.

In one aspect, the solid-state electrolyte layer may be flexible. The solid-state electrolyte layer may have a Young's modulus of less than or equal to about 20 GPa.

In various aspects, the present disclosure may provide yet another method for forming ionically conductive polymer composite interlayers. The method may include disposing a first precursor layer on or adjacent to a first surface of a solid-state electrolyte layer; disposing a second precursor layer on or adjacent to a second surface of the solid-state electrolyte layer, where each of the first and second precursor layers includes one or more fluoropolymers including carbon and fluorine; disposing a first electroactive material layer on or adjacent to an exposed surface of the first precursor layer; disposing a second electroactive material layer on or adjacent to an exposed surface of the second precursor layer; and applying at least one of pressure and heat to the first and second precursor layers so as to form a first ionically conductive polymer composite interlayer between the solid-state electrolyte layer and the first electroactive material layer and a second ionically conductive polymer composite interlayer between the solid-state electrolyte and the second electroactive material layer. The first and second ionically conductive polymer composite layers may have ionic conductivities greater than or equal to about 1.0×10⁻⁸ S·cm⁻¹ to less than or equal to about 1.0 S·cm⁻¹ and each may include lithium fluoride embedded in a carbonaceous matrix.

In one aspect, each of the first and second electroactive material layers may include lithium metal and the applied pressure may be greater than a yield strength of the lithium metal.

In one aspect, the applied heat may be greater than or equal to about 80° C. to less than or equal to about 180° C.

In one aspect, the one or more fluoropolymers may be selected from the group consisting of: polyvinylfluoride (PVF), polyvinylidene fluoride (PVDF), polytetrafluoroethylene (PTFE), polychlorotrifluoroethylene (PCTFE), perfluoroalkoxy polymer (PFA/MFA), fluorinated ethylene-propylene (FEP), polyethylenetetrafluoroethylene (ETFE), polyethylenechlorotrifluoroethyl ene (ECTFE), perfluorinated elastomer (FFPM/FFKM), tetrafluoroethylene-propylene (FEPM), perfluoropolyether (PEPE), perfluorosulfonic acid (PFSA), and combinations thereof.

In one aspect, each of the first and second precursor layers may have a thickness of greater than or equal to about 5 nm to less than or equal to about 5 μm.

In one aspect, the solid-state electrolyte layer may be flexible. The solid-state electrolyte layer may have a Young's modulus of less than or equal to about 20 GPa.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an example solid-state battery in accordance with various aspects of the present disclosure;

FIG. 2 is an illustration of an example electrode including an ionically conductive polymer composite interlayer disposed between the electroactive material layer and the solid-state electrolyte in accordance with various aspects of the present disclosure;

FIG. 3 is a flow chart of an example method for forming an ionically conductive polymer composite interlayer, such as illustrated in FIG. 2, in accordance with various aspects of the present disclosure;

FIG. 4 is a flow chart of another example method for forming an ionically conductive polymer composite interlayer, such as illustrated in FIG. 2, in accordance with various aspects of the present disclosure;

FIG. 5 is an illustration of yet another example method for forming an ionically conductive polymer composite interlayer, such as illustrated in FIG. 2, in accordance with various aspects of the present disclosure;

FIG. 6A is a graphical illustration demonstrating the electrochemical impedance spectroscopy (EIS) for an electrode, where an ionically conductive polymer composite interlayer is disposed between an electroactive material layer and an adjacent solid-state electrolyte layer, in accordance with various aspects of the present disclosure;

FIG. 6B is a graphical illustration demonstrating the electrochemical impedance spectroscopy (EIS) for an electrode including an electroactive material layer and an adjacent solid-state electrolyte layer;

FIG. 7A is a graphical illustration demonstrating cyclability for a cell including an electrode that includes an ionically conductive polymer composite interlayer disposed between an electroactive material layer and an adjacent solid-state electrolyte layer in accordance with various aspects of the present disclosure; and

FIG. 7B is a graphical illustration demonstrating cyclability for a cell including an electrode that includes an electroactive material layer and an adjacent solid-state electrolyte layer.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The current technology pertains to solid-state batteries (SSBs), for example only, bipolar solid-state batteries, and methods of forming and using the same. Solid-state batteries may include at least one solid component, for example, at least one solid electrode, but may also include semi-solid or gel, liquid, or gas components, in certain variations. Solid-state batteries may have a bipolar stacking design comprising a plurality of bipolar electrodes where a first mixture of solid-state electroactive material particles (and optional solid-state electrolyte particles) is disposed on a first side of a current collector, and a second mixture of solid-state electroactive material particles (and optional solid-state electrolyte particles) is disposed on a second side of a current collector that is parallel with the first side. The first mixture may include, as the solid-state electroactive material particles, positive electrode or cathode material particles. The second mixture may include, as solid-state electroactive material particles, negative electrode or anode material particles. The solid-state electrolyte particles in each instance may be the same or different.

Such solid-state batteries may be incorporated into energy storage devices, like rechargeable lithium-ion batteries, which may be used in automotive transportation applications (e.g., motorcycles, boats, tractors, buses, mobile homes, campers, and tanks). The present technology, however, may also be used in other electrochemical devices, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. In various aspects, the present disclosure provides a rechargeable lithium-ion battery that exhibits high temperature tolerance, as well as improved safety and superior power capability and life performance.

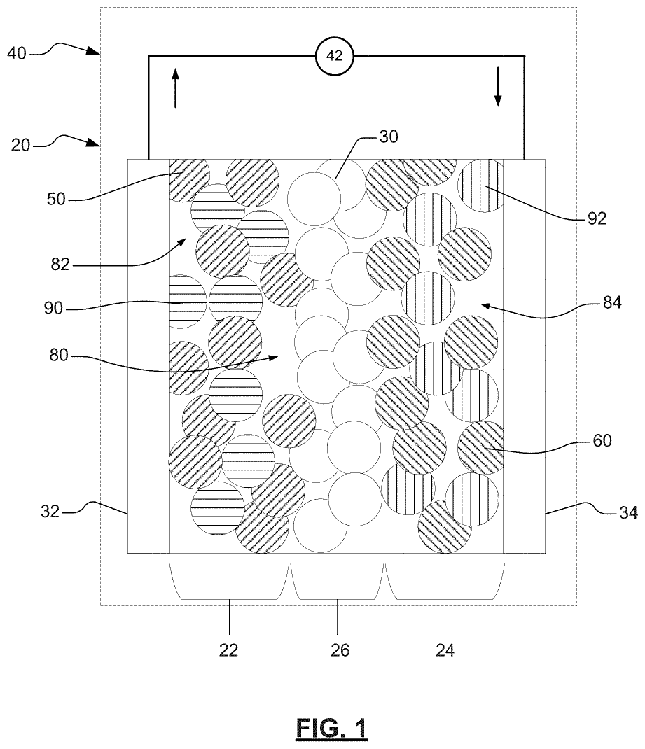

An exemplary and schematic illustration of a solid-state electrochemical cell unit (also referred to as a “solid-state battery” and/or “battery”) 20 that cycles lithium ions is shown in FIG. 1. The battery 20 includes a negative electrode (i.e., anode) 22, a positive electrode (i.e., cathode) 24, and an electrolyte layer 26 that occupies a space defined between the two or more electrodes. The electrolyte layer 26 is a solid-state or semi-solid state separating layer that physically separates the negative electrode 22 from the positive electrode 24. The electrolyte layer 26 may include a first plurality of solid-state electrolyte particles 30. A second plurality of solid-state electrolyte particles 90 may be mixed with negative solid-state electroactive particles 50 in the negative electrode 22, and a third plurality of solid-state electrolyte particles 92 may be mixed with positive solid-state electroactive particles 60 in the positive electrode 24, so as to form a continuous electrolyte network, which may be a continuous lithium-ion conduction network.

A negative electrode current collector 32 may be positioned at or near the negative electrode 22. A positive electrode current collector 34 may be positioned at or near the positive electrode 24. The negative electrode current collector 32 may be formed from copper or any other appropriate electrically conductive material known to those of skill in the art. The positive electrode current collector 34 may be formed from aluminum or any other electrically conductive material known to those of skill in the art. The negative electrode current collector 32 and the positive electrode current collector 34 respectively collect and move free electrons to and from an external circuit 40 (as shown by the block arrows). For example, an interruptible external circuit 40 and a load device 42 may connect the negative electrode 22 (through the negative electrode current collector 32) and the positive electrode 24 (through the positive electrode current collector 34).

The battery 20 can generate an electric current (indicated by arrows in FIG. 1) during discharge by way of reversible electrochemical reactions that occur when the external circuit 40 is closed (to connect the negative electrode 22 and the positive electrode 24) and when the negative electrode 22 has a lower potential than the positive electrode 24. The chemical potential difference between the negative electrode 22 and the positive electrode 24 drives electrons produced by a reaction, for example, the oxidation of intercalated lithium, at the negative electrode 22, through the external circuit 40 towards the positive electrode 24. Lithium ions, which are also produced at the negative electrode 22, are concurrently transferred through the electrolyte layer 26 towards the positive electrode 24. The electrons flow through the external circuit 40 and the lithium ions migrate across the electrolyte layer 26 to the positive electrode 24, where they may be plated, reacted, or intercalated. The electric current passing through the external circuit 40 can be harnessed and directed through the load device 42 (in the direction of the arrows) until the lithium in the negative electrode 22 is depleted and the capacity of the battery 20 is diminished.

The battery 20 can be charged or reenergized at any time by connecting an external power source (e.g., charging device) to the battery 20 to reverse the electrochemical reactions that occur during battery discharge. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator. The connection of the external power source to the battery 20 promotes a reaction, for example, non-spontaneous oxidation of intercalated lithium, at the positive electrode 24 so that electrons and lithium ions are produced. The electrons, which flow back towards the negative electrode 22 through the external circuit 40, and the lithium ions, which move across the electrolyte layer 26 back towards the negative electrode 22, reunite at the negative electrode 22 and replenish it with lithium for consumption during the next battery discharge cycle. As such, a complete discharging event followed by a complete charging event is considered to be a cycle, where lithium ions are cycled between the positive electrode 24 and the negative electrode 22.

Although the illustrated example includes a single positive electrode 24 and a single negative electrode 22, the skilled artisan will recognize that the current teachings apply to various other configurations, including those having one or more cathodes and one or more anodes, as well as various current collectors and current collector films with electroactive particle layers disposed on or adjacent to or embedded within one or more surfaces thereof. Likewise, it should be recognized that the battery 20 may include a variety of other components that, while not depicted here, are nonetheless known to those of skill in the art. For example, the battery 20 may include a casing, a gasket, terminal caps, and any other conventional components or materials that may be situated within the battery 20, including between or around the negative electrode 22, the positive electrode 24, and/or the solid-state electrolyte 26 layer.

In many configurations, each of the negative electrode current collector 32, the negative electrode 22, the electrolyte layer 26, the positive electrode 24, and the positive electrode current collector 34 are prepared as relatively thin layers (for example, from several microns to a millimeter or less in thickness) and assembled in layers connected in series arrangement to provide a suitable electrical energy, battery voltage and power package, for example, to yield a Series-Connected Elementary Cell Core (“SECC”). In various other instances, the battery 20 may further include electrodes 22, 24 connected in parallel to provide suitable electrical energy, battery voltage, and power for example, to yield a Parallel-Connected Elementary Cell Core (“PECC”).

The size and shape of the battery 20 may vary depending on the particular applications for which it is designed. Battery-powered vehicles and hand-held consumer electronic devices are two examples where the battery 20 would most likely be designed to different size, capacity, voltage, energy, and power-output specifications. The battery 20 may also be connected in series or parallel with other similar lithium-ion cells or batteries to produce a greater voltage output, energy, and power if it is required by the load device 42. The battery 20 can generate an electric current to the load device 42 that can be operatively connected to the external circuit 40. The load device 42 may be fully or partially powered by the electric current passing through the external circuit 40 when the battery 20 is discharging. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 42 may also be an electricity-generating apparatus that charges the battery 20 for purposes of storing electrical energy.

With renewed reference to FIG. 1, the solid-state electrolyte layer 26 provides electrical separation—preventing physical contact—between the negative electrode 22 and the positive electrode 24. The solid-state electrolyte layer 26 also provides a minimal resistance path for internal passage of ions. In various aspects, the solid-state electrolyte layer 26 may be defined by a first plurality of solid-state electrolyte particles 30. For example, the solid-state electrolyte layer 26 may be in the form of a layer or a composite that comprises the first plurality of solid-state electrolyte particles 30. The solid-state electrolyte particles 30 may have an average particle diameter greater than or equal to about 0.02 μm to less than or equal to about 20 μm, optionally greater than or equal to about 0.1 μm to less than or equal to about 10 μm, and in certain aspects, optionally greater than or equal to about 0.1 μm to less than or equal to about 1 μm. The solid-state electrolyte layer 26 may be in the form of a layer having a thickness greater than or equal to about 5 μm to less than or equal to about 200 μm, optionally greater than or equal to about 10 μm to less than or equal to about 100 μm, optionally about 40 μm, and in certain aspects, optionally about 30 μm.

The solid-state electrolyte particles 30 may comprise one or more sulfide-based particles, oxide-based particles, metal-doped or aliovalent-substituted oxide particles, nitride-based particles, hydride-based particles, halide-based particles, and borate-based particles.

In certain variations, the oxide-based particles may comprise one or more garnet ceramics, LISICON-type oxides, NASICON-type oxides, and Perovskite type ceramics. For example, the garnet ceramics may be selected from the group consisting of: Li₇La₃Zr₂O₁₂, Li_{6.2}Ga_{0.3}La_{2.95}Rb_{0.05}Zr₂O₁₂, Li_{6.85}La_{2.9}Ca_{0.1}Zr^{1.75}Nb_{0.25}O₁₂, Li_{6.25}Al_{0.25}La₃Zr₂O₁₂, Li_{6.75}La₃Zr_{1.75}Nb_{0.25}O₁₂, and combinations thereof. The LISICON-type oxides may be selected from the group consisting of: Li₂₊₂ₓZn₁₋ₓGeO₄ (where 0<x<1), Li₁₄Zn(GeO₄)₄, Li₃₊ₓ(P₁₋ₓSiₓ)O₄ (where 0<x<1), Li₃₊ₓGeₓV₁₋ₓO₄ (where 0<x<1), and combinations thereof. The NASICON-type oxides may be defined by LiMM′(PO₄)₃, where M and M′ are independently selected from Al, Ge, Ti, Sn, Hf, Zr, and La. For example, in certain variations, the NASICON-type oxides may be selected from the group consisting of: Li₁₊ₓAlₓGe₂₋ₓ(PO₄)₃ (LAGP) (where 0≤x≤2), Li_{1.4}Al_{0.4}Ti_{1.6}(PO₄)₃, Li_{1.3}Al_{0.3}Ti_{1.7}(PO₄)₃, LiTi₂(PO₄)₃, LiGeTi(PO₄)₃, LiGe₂(PO₄)₃, LiHf₂(PO₄)₃, and combinations thereof. The Perovskite-type ceramics may be selected from the group consisting of: Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x=0.75y and 0.60<y<0.75), Li_{3/8}Sr_{7/16}Nb_{3/4}Zr_{1/4}O₃, Li₃xLa_{(2/3-x)}TiO₃ (where 0<x<0.25), and combinations thereof.

In certain variations, the metal-doped or aliovalent-substituted oxide particles may include, for example only, aluminum (Al) or niobium (Nb) doped Li₇La₃Zr₂O₁₂, antimony (Sb) doped Li₇La₃Zr₂O₁₂, gallium (Ga) doped Li₇La₃Zr₂O₁₂, chromium (Cr) and/or vanadium (V) substituted LiSn₂P₃O₁₂, aluminum (Al) substituted Li_{1+x+y}AlₓTi₂₋ₓSi_{Y}P_{3-y}O₁₂ (where 0<x<2 and 0<y<3), and combinations thereof.

In certain variations, the sulfide-based particles may include, for example only, a pseudobinary sulfide, a pseudoternary sulfide, and/or a pseudoquaternary sulfide. Example pseudobinary sulfide systems include Li₂S—P₂S₅ systems (such as, Li₃PS₄, Li₇P₃S₁₁, and Li_{9.6}P₃S₁₂), Li₂S—SnS₂ systems (such as, Li₄SnS₄), Li₂S—SiS₂ systems, Li₂S—GeS₂ systems, Li₂S—B₂S₃ systems, Li₂S—Ga₂S₃ system, Li₂S—P₂S₃ systems, and Li₂S—Al₂S₃ systems. Example pseudoternary sulfide systems include Li₂O—Li₂S—P₂S₅ systems, Li₂S—P₂S₅—P₂O₅ systems, Li₂S—P₂S₅—GeS₂ systems (such as, Li_{3.25}Ge_{0.25}P_{0.75}S₄ and Li₁₀GeP₂S₁₂), Li₂S—P₂S₅—LiX systems (where X is one of F, Cl, Br, and I) (such as, Li₆PS₅Br, Li₆PS₅Cl, L₇P₂S₈I, and Li₄PS₄I), Li₂S—As₂S₅—SnS₂ systems (such as, Li_{3.833}Sn_{0.833}As_{0.166}S₄), Li₂S—P₂S₅—Al₂S₃ systems, Li₂S—LiX—SiS₂ systems (where X is one of F, Cl, Br, and I), 0.4LiI·0.6Li₄SnS₄, and Li₁₁Si₂PS₁₂. Example pseudoquaternary sulfide systems include Li₂O—Li₂S—P₂S5—P₂O₅ systems, Li_{9.54}Si_{1.74}P_{1.44}S_{11.7}Cl_{0.3}, Li₇P_{2.9}Mn_{0.1}S_{10.7}I_{0.3}, and Li_{10.35}[Sn_{0.27}Si_{1.08}]P_{1.65}S₁₂.

In certain variations, the nitride-based particles may include, for example only, Li₃N, Li₇PN₄, LiSi₂N₃, and combinations thereof; the hydride-based particles may include, for example only, LiBH₄, LiBH₄—LiX (where x=Cl, Br, or I), LiNH₂, Li₂NH, LiBH₄—LiNH₂, Li₃AlH₆, and combinations thereof; the halide-based particles may include, for example only, LiI, Li₃InCl₆, Li₂CdC₁₄, Li₂MgCl₄, LiCdI₄, Li₂ZnI₄, Li₃OCl, Li₃YCl₆, Li₃YBr₆, and combinations thereof; and the borate-based particles may include, for example only, Li₂B₄O₇, Li₂O—B₂O₃—P₂O₅, and combinations thereof.

In various aspects, the first plurality of solid-state electrolyte particles 30 may include one or more electrolyte materials selected from the group consisting of: Li₂S—P₂S₅ system, Li₂S—P₂S₅—MOₓ system (where 1<x<7), Li₂S—P₂S₅—MSₓ system (where 1<x<7), Li₁₀GeP₂S₁₂ (LGPS), Li₆PS₅X (where X is Cl, Br, or I) (lithium argyrodite), Li₇P₂S₈I, Li_{10.35}Ge_{1.35}P_{1.65}S₁₂, Li_{3.25}Ge_{0.25}P_{0.75}S₄ (thio-LISICON), Li₁₀SnP₂S₁₂, Li₁₀SiP₂S₁₂, Li_{9.54}Si_{1.74}P_{1.44}S_{11.7}Cl_{0.3}, (1−x)P₂S₅₋ₓLi₂S (where 0.5≤x≤0.7), Li_{3.4}Si_{0.4}P_{0.6}S₄, PLi₁₀GeP₂S_{11.7}O_{0.3}, Li_{9.6}P₃S₁₂, Li₇P₃S₁₁, Li₉P₃S₉O₃, Li_{10.35}Ge_{1.35}P_{1.63}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.833}Sn_{0.833}As_{0.16}S₄, Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, Li_{6.75}La₃Zr_{1.75}Nb_{0.25}O₁₂, Li₂₊₂ₓZn₁₋ₓGeO₄ (where 0<x<1), Li₁₄Zn(GeO₄)₄, Li₃₊ₓ(P₁₋ₓSiₓ)O₄ (where 0<x<1), Li₃₊ₓGeₓV₁₋ₓO₄ (where 0<x<1), LiMM′(PO₄)₃ (where M and M′ are independently selected from Al, Ge, Ti, Sn, Hf, Zr, and La), Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x=0.75y and 0.60<y<0.75), Li_{3/8}Sr_{7/16}Nb_{3/4}Zr_{1/4}O₃, Li₃ₓLa_{(2/3-x)}TiO₃ (where 0<x<0.25), aluminum (Al) or niobium (Nb) doped Li₇La₃Zr₂O₁₂, antimony (Sb) doped Li₇La₃Zr₂O₁₂, gallium (Ga) doped Li₇La₃Zr₂O₁₂, chromium (Cr) and/or vanadium (V) substituted LiSn₂P₃O₁₂, aluminum (Al) substituted Li_{1+x+y}AlₓTi₂₋ₓSi_{Y}P_{3-y}O₁₂ (where 0<x<2 and 0<y<3), LiI—Li₄SnS₄, Li₄SnS₄, Li₃N, Li₇PN₄, LiSi₂N₃, LiBH₄, LiBH₄—LiX (where x=Cl, Br, or I), LiNH₂, Li₂NH, LiNH₂, Li₃AlH₆, LiI, Li₃InCl₆, Li₂CdC₁₄, Li₂MgCl₄, LiCdI₄, Li₂ZnI₄, Li₃OCl, Li₂B₄O₇, Li₂O—B₂O₃—P₂O₅, and combinations thereof.

In certain variations, the first plurality of solid-state electrolyte particles 30 may include one or more electrolyte materials selected from the group consisting of: Li₂S-P₂S₅ system, Li₂S-P₂S₅—MOₓ system (where 1<x<7), Li₂S—P₂S₅—MSₓ system (where 1<x<7), Li₁₀GeP₂S₁₂ (LGPS), Li_{P}S₅X (where X is Cl, Br, or I) (lithium argyrodite), Li₇P₂S₈I, Li_{10.35}Ge_{1.35}P_{1.65}S₁₂, Li_{3.25}Ge_{0.25}P_{0.75}S₄ (thio-LISICON), Li₁₀SnP₂S₁₂, Li₁₀SiP₂S₁₂, Li_{9.54}Si_{1.74}P_{1.44}S_{11.7}C_{10.3}, (1−x)P₂S₅—xLi₂S (where 0.5≤x≤0.7), Li_{3.4}Si_{0.4}P_{0.6}S₄, PLi₁₀GeP₂S_{11.7}O_{0.3}, Li_{9.6}P₃S₁₂, Li₇P₃S₁₁, Li₉P₃S₉O₃, Li_{10.35}Ge_{1.35}P_{1.63}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.833}Sn_{0.833}As_{0.16}S₄, and combinations thereof.

Although not illustrated, the skilled artisan will recognize that in certain instances, one or more binder particles may be mixed with the solid-state electrolyte particles 30. For example, in certain aspects the solid-state electrolyte layer 26 may include greater than or equal to about 0 wt. % to less than or equal to about 10 wt. %, and in certain aspects, optionally greater than or equal to about 0.5 wt. % to less than or equal to about 10 wt. %, of the one or more binders. The one or more polymeric binders may include, for example only, polyvinylidene difluoride (PVDF), polytetrafluoroethylene (PTFE), ethylene propylene diene monomer (EPDM) rubber, nitrile butadiene rubber (NBR), styrene-butadiene rubber (SBR), and lithium polyacrylate (LiPAA).

In certain instances, the solid-state electrolyte particles 30 (and the optionally one or more binder particles) may be wetted by a small amount of liquid electrolyte, for example, to improve ionic conduction between the solid-state electrolyte particles 30. The solid-state electrolyte particles 30 may be wetted by greater than or equal to about 0 wt. % to less than or equal to about 40 wt. %, optionally greater than or equal to about 0.1 wt. % to less than or equal to about 40 wt. %, and in certain aspects, optionally greater than or equal to about 5 wt. % to less or equal to about 10 wt. %, of the liquid electrolyte, based on the weight of the solid-state electrolyte particles 30. In certain variations, Li₇P₃S₁₁ may be wetted by an ionic liquid electrolyte including LiTFSI-triethylene glycol dimethyl ether.

The positive electrode 24 may be formed from a lithium-based or electroactive material that can undergo lithium intercalation and deintercalation while functioning as the positive terminal of the battery 20. For example, in certain variations, the positive electrode 24 may be defined by a plurality of the positive solid-state electroactive particles 60. In certain instances, as illustrated, the positive electrode 24 is a composite comprising a mixture of the positive solid-state electroactive particles 60 and the third plurality of solid-state electrolyte particles 92. For example, the positive electrode 24 may include greater than or equal to about 30 wt. % to less than or equal to about 98 wt. %, and in certain aspects, optionally greater than or equal to about 50 wt. % to less than or equal to about 95 wt. %, of the positive solid-state electroactive particles 60 and greater than or equal to about 0 wt. % to less than or equal to about 50 wt. %, and in certain aspects, optionally greater than or equal to about 5 wt. % to less than or equal to about 20 wt. %, of the third plurality of solid-state electrolyte particles 92. Such positive electrodes 24 may have an interparticle porosity 84 between the positive solid-state electroactive particles 60 and/or the third plurality of solid-state electrolyte particles 92 that is greater than or equal to about 0 vol. % to less than or equal to about 50 vol. %.

The third plurality of solid-state electrolyte particles 92 may be the same as or different from the first and/or second pluralities of solid-state electrolyte particles 30, 90. In certain variations, the positive electrode 24 may be one of a layered-oxide cathode, a spinel cathode, and a polyanion cathode. For example, in the instances of a layered-oxide cathode (e.g., rock salt layered oxides), the positive solid-state electroactive particles 60 may comprise one or more positive electroactive materials selected from LiCoO₂, LiNiₓMn_{y}Co_{1-x-y}O₂ (where 0≤x≤1 and 0≤y≤1), LiNiₓMn_{y}Al_{1-x-y}O₂ (where 0<x≤1 and 0<y≤1), LiNiₓMn₁₋ₓO₂ (where 0≤x≤1), and Li₁₊ₓMO₂ (where 0≤x≤1) for solid-state lithium-ion batteries. The spinel cathode may include one or more positive electroactive materials, such as LiMn₂O₄ and LiNi_{0.5}Mn_{1.5}O₄. The polyanion cation may include, for example, a phosphate, such as LiFePO₄, LiVPO₄, LiV₂(PO₄)₃, Li₂FePO₄F, Li₃Fe₃(PO₄)₄, or Li₃V₂(PO₄)F₃ for lithium-ion batteries, and/or a silicate, such as LiFeSiO₄ for lithium-ion batteries. In this fashion, in various aspects, the positive solid-state electroactive particles 60 may comprise one or more positive electroactive materials selected from the group consisting of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof. In certain aspects, the positive solid-state electroactive particles 60 may be coated (for example, by LiNbO₃ and/or Al₂O₃) and/or the positive electroactive material may be doped (for example, by aluminum and/or magnesium).

In certain variations, the positive electrode 24 may further include one or more conductive additives and/or binder materials. For example, the positive solid-state electroactive particles 60 (and/or third plurality of solid-state electrolyte particles 92) may be optionally intermingled with one or more electrically conductive materials (not shown) that provide an electron conduction path and/or at least one polymeric binder material (not shown) that improves the structural integrity of the positive electrode 24.

For example, the positive solid-state electroactive particles 60 (and/or third plurality of solid-state electrolyte particles 92) may be optionally intermingled with binders, like polyvinylidene difluoride (PVDF), polytetrafluoroethylene (PTFE), ethylene propylene diene monomer (EPDM) rubber, nitrile butadiene rubber (NBR), styrene-butadiene rubber (SBR), polyethylene glycol (PEO), and/or lithium polyacrylate (LiPAA) binders. Electrically conductive materials may include, for example, carbon-based materials or a conductive polymer. Carbon-based materials may include, for example, particles of graphite, acetylene black (such as KETCHEN™ black or DENKA™ black), carbon fibers and nanotubes, graphene (such as graphene oxide), carbon black (such as Super P), and the like. Examples of a conductive polymer may include polyaniline, polythiophene, polyacetylene, polypyrrole, and the like. In certain aspects, mixtures of the conductive additives and/or binder materials may be used.

The positive electrode 24 may include greater than or equal to about 0 wt. % to less than or equal to about 30 wt. %, and in certain aspects, optionally greater than or equal to about 2 wt. % to less than or equal to about 10 wt. %, of the one or more electrically conductive additives; and greater than or equal to about 0 wt. % to less than or equal to about 20 wt. %, and in certain aspects, optionally greater than or equal to about 1 wt. % to less than or equal to about 10 wt. %, of the one or more binders.

The negative electrode 22 may be formed from a lithium host material that is capable of functioning as a negative terminal of a lithium-ion battery. For example, in certain variations, the negative electrode 22 may be defined by a plurality of the negative solid-state electroactive particles 50. In certain instances, as illustrated, the negative electrode 22 is a composite comprising a mixture of the negative solid-state electroactive particles 50 and the second plurality of solid-state electrolyte particles 90. For example, the negative electrode 22 may include greater than or equal to about 30 wt. % to less than or equal to about 98 wt. %, and in certain aspects, optionally greater than or equal to about 50 wt. % to less than or equal to about 95 wt. %, of the negative solid-state electroactive particles 50 and greater than or equal to about 0 wt. % to less than or equal to about 50 wt. %, and in certain aspects, optionally greater than or equal to about 5 wt. % to less than or equal to about 20 wt. %, of the second plurality of solid-state electrolyte particles 90. Such negative electrodes 22 may have an interparticle porosity 82 between the negative solid-state electroactive particles 50 and/or the second plurality of solid-state electrolyte particles 90 that is greater than or equal to about 0 vol. % to less than or equal to about 50 vol. %.

The second plurality of solid-state electrolyte particles 90 may be the same as or different from the first plurality of solid-state electrolyte particles 30. In certain variations, the negative solid-state electroactive particles 50 may comprise one or more negative electroactive materials, such a lithium alloy or a lithium metal.

In certain variations, the negative electrode 22 further includes one or more conductive additives and/or binder materials. For example, the negative solid-state electroactive particles 50 (and/or second plurality of solid-state electrolyte particles 90) may be optionally intermingled with one or more electrically conductive materials (not shown) that provide an electron conduction path and/or at least one polymeric binder material (not shown) that improves the structural integrity of the negative electrode 22.

For example, the negative solid-state electroactive particles 50 (and/or second plurality of solid-state electrolyte particles 90) may be optionally intermingled with binders, such as polyvinylidene difluoride (PVDF), polytetrafluoroethylene (PTFE), ethylene propylene diene monomer (EPDM) rubber, nitrile butadiene rubber (NBR), styrene-butadiene rubber (SBR), polyethylene glycol (PEO), and/or lithium polyacrylate (LiPAA) binders. Electrically conductive materials may include, for example, carbon-based materials or a conductive polymer. Carbon-based materials may include, for example, particles of graphite, acetylene black (such as KETCHEN™ black or DENKA™ black), carbon fibers and nanotubes, graphene (such as graphene oxide), carbon black (such as Super P), and the like. Examples of a conductive polymer may include polyaniline, polythiophene, polyacetylene, polypyrrole, and the like. In certain aspects, mixtures of the conductive additives and/or binder materials may be used.

The negative electrode 22 may include greater than or equal to about 0 wt. % to less than or equal to about 30 wt. %, and in certain aspects, optionally greater than or equal to about 2 wt. % to less than or equal to about 10 wt. %, of the one or more electrically conductive additives; and greater than or equal to about 0 wt. % to less than or equal to about 20 wt. %, and in certain aspects, optionally greater than or equal to about 1 wt. % to less than or equal to about 10 wt. %, of the one or more binders.

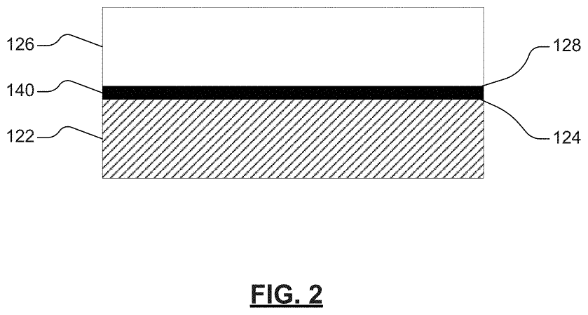

In various aspects, as illustrated in FIG. 2, a negative electrode, like negative electrode 22 illustrated in FIG. 1, may be a lithium metal electrode 122. Similar to negative electrode 22, the lithium metal electrode 122 may be substantially aligned with a solid-state electrolyte layer 126—that is, a surface 124 of the lithium metal electrode 122 may oppose, or interface with, a surface 128 of the solid-state electrolyte layer 126. In certain variations, an ionically conductive polymer composite interlayer 140 may be disposed between the lithium metal electrode 122 and the solid-state electrolyte layer 126. The ionically conductive polymer composite interlayer 140 may have a thickness of greater than or equal to about 5 nm to less than or equal to about 5 μm. The ionically conductive polymer composite interlayer 140 may have an ionic conductivity greater than or equal to about 1.0×10⁻⁸ S·cm⁻¹ to less than or equal to about 1.0 S·cm⁻¹.

The ionically conductive polymer composite interlayer 140 may be a lithium-fluoride based nanocomposite coating or layer, which can help to reduce interfacial impedance between the lithium metal electrode 122 and the solid-state electrolyte 126. For example, the ionically conductive polymer composite interlayer 140 may comprise a lithium fluoride embedded in a carbonaceous matrix. The lithium fluoride may be homogeneously distributed throughout the matrix. In certain variations, the ionically conductive polymer composite interlayer 140 may include greater than or equal to about 10 wt % to less than or equal to about 80 wt. % of the carbon matrix. The carbon matrix may have a sp2/sp3 ratio of carbon bonds greater than or equal to about 30% to less than or equal to about 70%.

In various aspects, impedance at the interface between the lithium metal electrode 122 and the solid-state electrolyte 126 may be a result of volumetric changes, contract area loss caused by mismatches in mechanical properties, and/or ion diffusion or element inter-diffusion. The ionically conductive polymer composite interlayer 140, as a superhydrophobic surface, may help to reduce interfacial impedance between the lithium metal electrode 122 and the solid-state electrolyte 126 by limiting reactions between the surface 124 of the lithium metal electrode 122 and the solid-state electrolyte 126 and/or moisture and air during cell fabrication. The ionically conductive polymer composite interlayer 140 may also help to reduce interfacial impedance between the lithium metal electrode 122 and the solid-state electrolyte 126 by reducing voids along the interface. Voids along the interface may be reduced because the fluoropolymer, having a higher adhesion energy with the lithium metal electrode 122 than the solid-state electrolyte 126, more effectively passivates the surface 124 of the lithium metal electrode 122.

In various aspects, the present disclosure provides a method for forming an ionically conductive polymer composite interlayer between a surface of a negative electrode and a surface of a solid-state electrolyte, where the surface of the negative electrode and the surface of the solid-state electrolyte are substantially aligned, such as the ionically conductive polymer composite interlayer 140 illustrated in FIG. 2. For example, the method for forming an ionically conductive polymer composite interlayer between one or more surfaces of a negative electrode and one or more surfaces of a solid-state electrolyte may generally include disposing a precursor layer on one or more surfaces of a negative electrode or one or more surfaces of a solid-state electrolyte, and converting the precursor layer, using heat and/or pressure, to the ionically conductive polymer composite. Although the following examples discuss a single surface of a single negative electrode and a single surface of a single solid-state electrolyte, the skilled artisan will understand that similar treatments or processes may be applied to one or more other surfaces of the negative electrode or solid-state electrolyte and/or one or more negative electrodes or solid-state electrolytes.

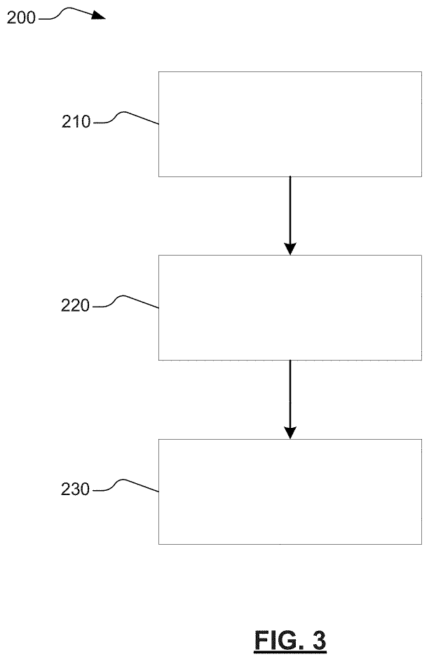

An example method 200 for forming an ionically conductive polymer composite interlayer between one or more surfaces of a negative electrode and one or more surfaces of a solid-state electrolyte is illustrated in FIG. 3. The method 200 may include disposing 210 a precursor layer on a surface of a negative electrode (e.g., lithium metal electrode). The precursor layer may be disposed on the surface of the negative electrode using a vapor deposition process (such as, physical vapor deposition (PVD), chemical vapor deposition (CVD), atomic layer deposition (ALD), and the like) or a solution deposition (such as, dip coating, spin coating, and the like).

The precursor layer may be a fluoropolymer layer that includes one or more fluoropolymers selected from polyvinylfluoride (PVF), polyvinylidene fluoride (PVDF), polytetrafluoroethylene (PTFE), polychlorotrifluoroethylene (PCTFE), perfluoroalkoxy polymer (PFA/MFA), fluorinated ethylene-propylene (FEP), polyethyl enetetrafluoroethylene (ETFE), polyethylenechlorotrifluoroethyl ene (ECTFE), perfluorinated elastomer (FFPM/FFKM), tetrafluoroethylene-propylene (FEPM), perfluoropolyether (PEPE), perfluorosulfonic acid (PFSA), or any combination thereof. The precursor layer may be a flexible layer (e.g., Young's modulus less than about 20 GPa) having a thickness of greater than or equal to about 5 nm to less than or equal to about 5 μm.

The method 200 may further include stacking or substantially aligning 220 the negative electrode including the precursor layer and a solid-state electrolyte. The negative electrode including the precursor layer and the solid-state electrolyte may be stacked. In certain variations, stacking or substantially aligning 220 the negative electrode including the precursor layer and the solid-state electrolyte may include applying pressure to the negative electrode including the precursor layer and the solid-state electrolyte. For example, a pressure greater than the yield strength of the negative electrode (e.g., greater than or equal to about 0.5 MPa) may be applied to the stack for a period greater than or equal to about 1 minute to less than or equal to about 10 hours. Upon the application of pressure, the flexible precursor layer flows so as to fill voids or gaps between the negative electrode and the solid-state electrolyte.

The method 200 may further include heating 230 the precursor layer so as to promote defluorination and formation of the ionically conductive polymer composite interlayer between the negative electrode and the solid-state electrolyte. In certain variations, the applied heat is greater than or equal to about 80° C. to less than or equal to about 180° C. The heat may be applied using an oven or infrared light for a period greater than or equal to about 30 seconds to less than or equal to about 30 minutes. The ionically conductive polymer composite interlayer may comprise a lithium fluoride embedded in a carbonaceous matrix. The lithium fluoride may be homogeneously distributed throughout the matrix. In certain variations, the ionically conductive polymer composite interlayer may include greater than or equal to about 10 wt % to less than or equal to about 80 wt. % of the carbon matrix. The carbon matrix may have a sp2/sp3 ratio of carbon bonds greater than or equal to about 30% to less than or equal to about 70%. In various aspects, an example reaction between the lithium of the electroactive material layer and/or the solid-state electrolyte with the fluoropolymer (which includes fluoride and carbon) of the precursor layer may be represented by formula (I):

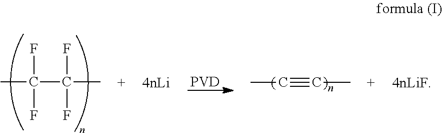

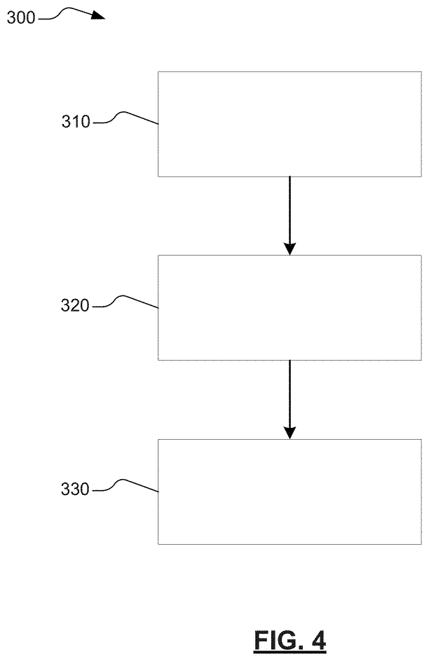

Another example method 300 for forming an ionically conductive polymer composite interlayer between a surface of a negative electrode and a surface of a solid-state electrolyte is illustrated in FIG. 4. The method 300 may include disposing 310 a precursor layer on a surface of a solid-state electrolyte. The precursor layer may be disposed on the surface of the solid-state electrolyte using a vapor deposition process (such as, physical vapor deposition (PVD), chemical vapor deposition (CVD), atomic layer deposition (ALD), and the like) or a solution deposition (such as, dip coating, spin coating, and the like).

The precursor layer may be a fluoropolymer layer that includes one or more fluoropolymers selected from polyvinylfluoride (PVF), polyvinylidene fluoride (PVDF), polytetrafluoroethylene (PTFE), polychlorotrifluoroethylene (PCTFE), perfluoroalkoxy polymer (PFA/MFA), fluorinated ethylene-propylene (FEP), polyethyl enetetrafluoroethylene (ETFE), polyethylenechlorotrifluoroethyl ene (ECTFE), perfluorinated elastomer (FFPM/FFKM), tetrafluoroethylene-propylene (FEPM), perfluoropolyether (PEPE), perfluorosulfonic acid (PFSA), or any combination thereof. The precursor layer may be a flexible layer (e.g., Young's modulus less than about 20 GPa) having a thickness of greater than or equal to about 5 nm to less than or equal to about 5 μm.

The method 300 may further include stacking or substantially aligning 320 the solid-state electrolyte including the precursor layer and a negative electrode (e.g., lithium metal electrode). The solid-state electrolyte including the precursor layer and the negative electrode may be stacked. In certain variations, stacking or substantially aligning 320 the solid-state electrolyte including the precursor layer and the negative electrode may include applying pressure to the solid-state electrolyte including the precursor layer and the negative electrode. For example, a pressure greater than the yield strength of the negative electrode (e.g., greater than or equal to about 0.5 MPa) may be applied to the stack for a period greater than or equal to about 1 minute to less than or equal to about 10 hours. Upon the application of pressure, the flexible precursor layer flows so as to fill voids or gaps between the solid-state electrolyte and the negative electrode.

The method 300 may further include heating 330 the precursor layer so as to promote defluorination and formation of the ionically conductive polymer composite interlayer between the solid-state electrolyte and the negative electrode. In certain variations, the applied heat is greater than or equal to about 80° C. to less than or equal to about 180° C. The heat may be applied using an oven or infrared light for a period greater than or equal to about 30 seconds to less than or equal to about 30 minutes. The ionically conductive polymer composite interlayer may comprise a lithium fluoride embedded in a carbonaceous matrix. The lithium fluoride may be homogeneously distributed throughout the matrix. In certain variations, the ionically conductive polymer composite interlayer may include greater than or equal to about 10 wt % to less than or equal to about 80 wt. % of the carbon matrix. The carbon matrix may have a sp2/sp3 ratio of carbon bonds greater than or equal to about 30% to less than or equal to about 70%.

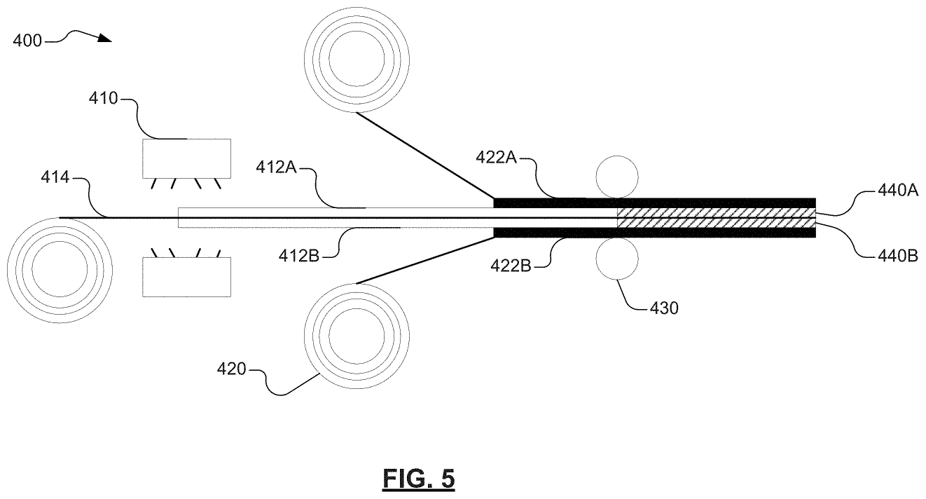

Another example method 400 for forming an ionically conductive polymer composite interlayer between a surface of a negative electrode and a surface of a flexible solid-state electrolyte (e.g., Young's modulus less than about 20 GPa) is illustrated in FIG. 5. As illustrated, the method 400 may be a continuous roll-to-roll process that includes disposing 410 a precursor layer 412 on one or more surfaces of a negative electrode 414 (e.g., lithium metal electrode). For example, a first precursor layer 412A may be disposed on or adjacent to a first surface of the negative electrode 414, and a second precursor layer 412B may be disposed on or adjacent to a second surface of the negative electrode 414. In each instance, the precursor layer 412A, 412B may be disposed on the surface of the solid-state electrolyte using a vapor deposition process (such as, physical vapor deposition (PVD), chemical vapor deposition (CVD), atomic layer deposition (ALD), and the like) or a solution deposition (such as, dip coating, spin coating, and the like).

The precursor layers 412A, 412B may be the same or different. For example, the precursor layers 412A, 412B may each be fluoropolymer layers that include one or more fluoropolymers selected from polyvinylfluoride (PVF), polyvinylidene fluoride (PVDF), polytetrafluoroethylene (PTFE), polychlorotrifluoroethylene (PCTFE), perfluoroalkoxy polymer (PFA/MFA), fluorinated ethylene-propylene (FEP), polyethylenetetrafluoroethylene (ETFE), polyethylenechlorotrifluoroethylene (ECTFE), perfluorinated elastomer (FFPM/FFKM), tetrafluoroethylene-propylene (FEPM), perfluoropolyether (PEPE), perfluorosulfonic acid (PFSA), or any combination thereof. The precursor layers 412A, 412B may be a flexible layer (e.g., Young's modulus less than 20 GPa) having a thickness of greater than or equal to about 5 nm to less than or equal to about 5 μm.

The method 400 may include disposing 420 flexible solid-state electrolyte layers 422A, 422B on the exposed surfaces of the one or more precursor layers 412. For example, a first solid-state electrolyte layer 422A may be disposed on or adjacent to the first precursor layer 412A, and a second solid electrolyte layer 422B may be disposed on or adjacent to the second precursor layer 412B. The flexible solid-state electrolyte layers 422, 422B may include oxides, sulfides, phosphates (such as, lithium superionic conductor (LISICON), Li₁₀GeP₂S₁₂ (LGPS), LiSiPS, LiPS, argyrodite-like (Li₆PS₅X, where X is one of Cl, Br, I, or a combination thereof), garnets based oxides (Li₇La₃Zr₂O₁₂ (LLZO)), sodium superionic conductor NASICON (e.g. lithium titanium phosphate (LTP), lithium aluminum titanium phosphate (LATP), Li₁₊ₓAlₓGe₂₋ₓ(PO₄)₃, where 0≤x≤2 (LAGP), lithium nitrides (Li₃N), lithium hydrides (LiBH₄), perovskites (lithium lanthanum titanate (LLTO)), lithium halides, or any combination thereof.

The method 400 may include applying pressure and/or heat to the stack, including the negative electrode 414, the first and second precursor layers 412A, 412B, and the first and second solid-state electrolyte layers 422A, 422B.

For example, a pressure greater than the yield strength of the negative electrode 414 (e.g., greater than or equal to about 0.5 MPa) may be applied to the stack for a period greater than or equal to about 1 minute to less than or equal to about 10 hours. Upon the application of pressure, the flexible precursor layers 412A, 412B may flow so as to fill voids or gaps between the solid-state electrolyte layers 422A, 422B and the negative electrode 414.

The applied heat may be greater than or equal to about 80° C. to less than or equal to about 180° C. The heat may be applied using an oven or an infrared light for a period greater than or equal to about 30 seconds to less than or equal to about 30 minutes. Applying heat to the stack may promote defluorination and formation of the ionically conductive polymer composite interlayers 440A, 440B between the negative electrode 414 and the solid-state electrolyte layers 422A, 422B. The ionically conductive polymer composite interlayers 440A, 400B comprise a lithium fluoride embedded in a carbonaceous matrix. The lithium fluoride may be homogeneously distributed throughout the matrix. In certain variations, the ionically conductive polymer composite interlayers 440A, 440B may each include greater than or equal to about 10 wt % to less than or equal to about 80 wt. % of the carbon matrix. In each instance, the carbon matrix may have a sp2/sp3 ratio of carbon bonds greater than or equal to about 30% to less than or equal to about 70%.

Certain features of the current technology are further illustrated in the following non-limiting examples.

### Example 1

An example electrode may be prepared in accordance with various aspects of the present disclosure. The example cell may include a solid-state electrolyte layer disposed between a first electrode (e.g., first lithium-metal electrode) and a second electrode (e.g., second lithium-metal electrode). The first electrode may include a first electroactive material layer (that includes, for example, a lithium metal) disposed on or adjacent to a first current collector (that includes, for example, copper). The second electrode may include a second electroactive material layer (that includes, for example, a lithium metal) disposed on or adjacent to a second current collector (that includes, for example, copper). The first electroactive material layer and the second electroactive material layer may be substantially aligned with the solid-state electrolyte layer. For example, the first electroactive material layer may be substantially aligned with a first surface of the solid-state electrolyte layer, and the second electroactive material layer may be substantially aligned with a second surface of the solid-state electrolyte layer. The first surface of the solid-state electrolyte layer may be substantially parallel with the second surface of the solid-state electrolyte layer. In accordance with various aspects of the present disclosure, a first ionically conductive polymer composite interlayer may be disposed between the first electroactive material layer and the first surface of the solid-state electrolyte layer; and a second ionically conductive polymer composite interlayer may be disposed between the second electroactive material layer and the second surface of the solid-state electrolyte layer.

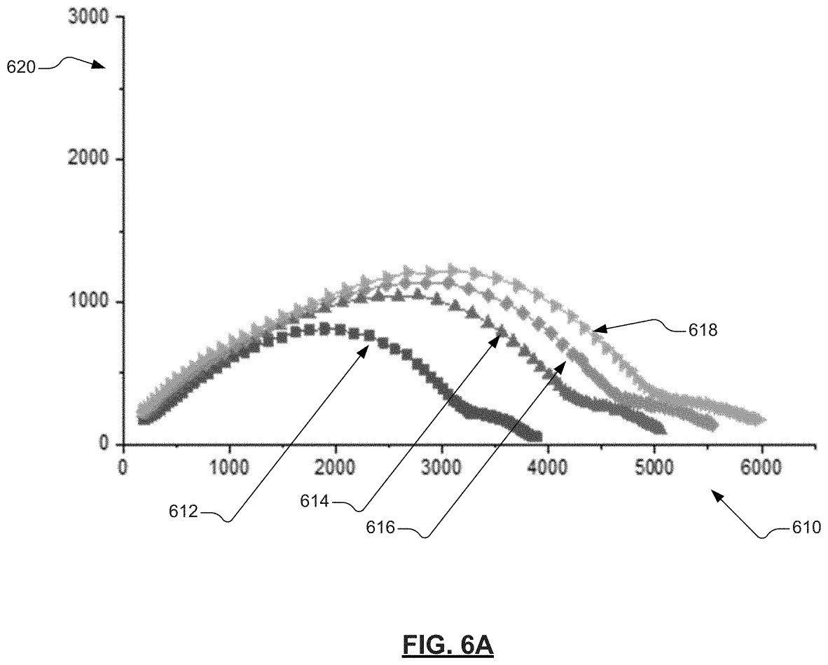

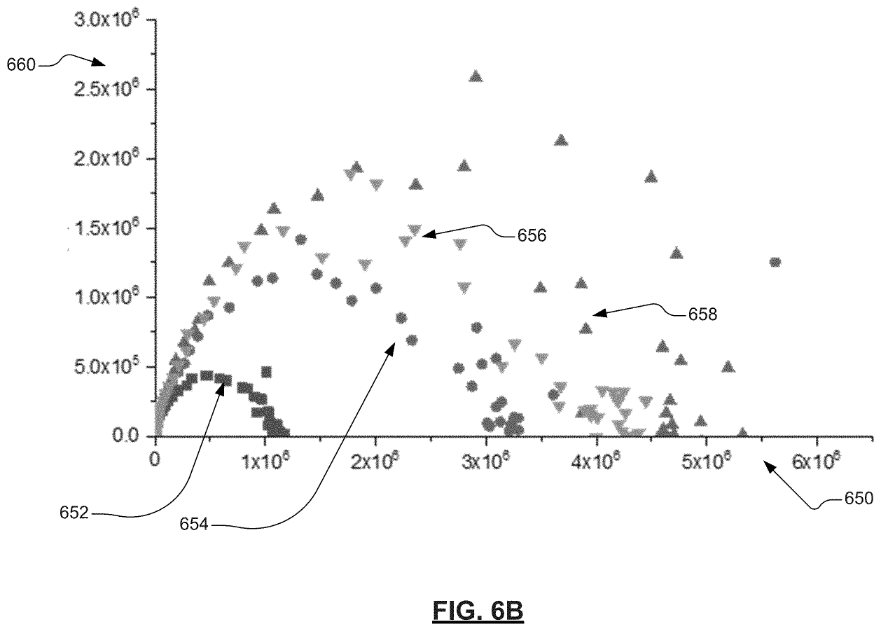

FIG. 6A is a graphical illustration demonstrating the electrochemical impedance spectroscopy (EIS) for the example electrode including the first and second ionically conductive polymer composite interlayer, where the x-axis 610 is the real part (Re(Z)/Ohm) and the y-axis 620 is the imaginary part (−Im(Z)/ohm). The first line 612 is the electrochemical impedance spectroscopy (EIS) at time zero. The second line 614 is the electrochemical impedance spectroscopy (EIS) at 1 hour. The third line 616 is the electrochemical impedance spectroscopy (EIS) at 2 hours. The final line 618 is the electrochemical impedance spectroscopy (EIS) at 3 hours.

By way of comparison, FIG. 6B is a graphical illustration demonstrating the electrochemical impedance spectroscopy (EIS) for another example electrode having the same configuration as the example electrode illustrated in FIG. 6A, but omitting the first and second ionically conductive polymer composite interlayers where the x-axis 650 is the real part(Re(Z)/Ohm) and the y-axis 660 is the imaginary part (−Im(Z)/ohm). The first line 652 is the electrochemical impedance spectroscopy (EIS) at time zero. The second line 654 is the electrochemical impedance spectroscopy (EIS) at 1 hour. The third line 656 is the electrochemical impedance spectroscopy (EIS) at 2 hours. The final line 658 is the electrochemical impedance spectroscopy (EIS) at 3 hours.

As illustrated, the example electrode including the ionically conductive polymer composite interlayers has reduced interfacial impedance, for example, from about 10⁶ ohm to about 10³ ohm.

### Example 2

An example electrode may be prepared in accordance with various aspects of the present disclosure. The example cell may include a solid-state electrolyte layer disposed between a first electrode (e.g., first lithium-metal electrode) and a second electrode (e.g., second lithium-metal electrode). The first electrode may include a first electroactive material layer (that includes, for example, a lithium metal) disposed on or adjacent to a first current collector (that includes, for example, copper). The second electrode may include a second electroactive material layer (that includes, for example, a lithium metal) disposed on or adjacent to a second current collector (that includes, for example, copper). The first electroactive material layer and the second electroactive material layer may be substantially aligned with the solid-state electrolyte layer. For example, the first electroactive material layer may be substantially aligned with a first surface of the solid-state electrolyte layer, and the second electroactive material layer may be substantially aligned with a second surface of the solid-state electrolyte layer. The first surface of the solid-state electrolyte layer may be substantially parallel with the second surface of the solid-state electrolyte layer. In accordance with various aspects of the present disclosure, a first ionically conductive polymer composite interlayer may be disposed between the first electroactive material layer and the first surface of the solid-state electrolyte layer; and a second ionically conductive polymer composite interlayer may be disposed between the second electroactive material layer and the second surface of the solid-state electrolyte layer.

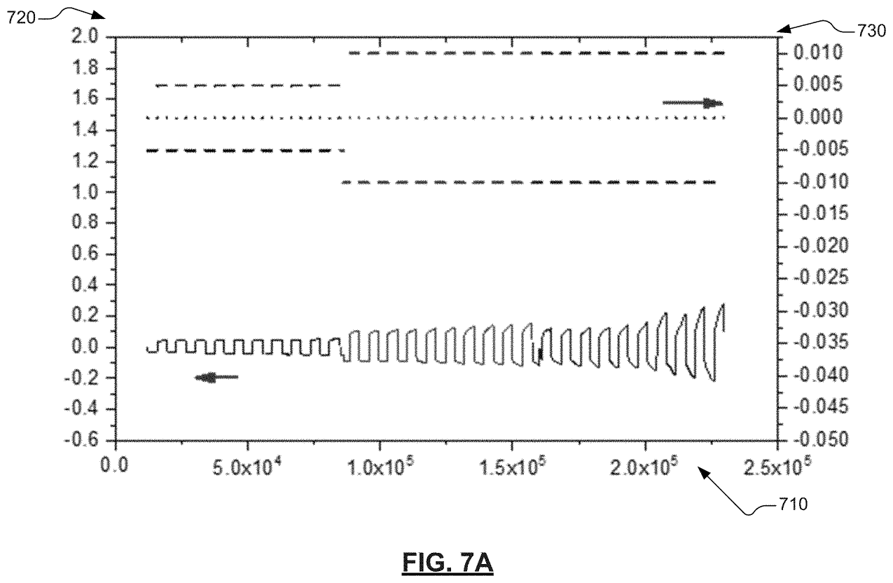

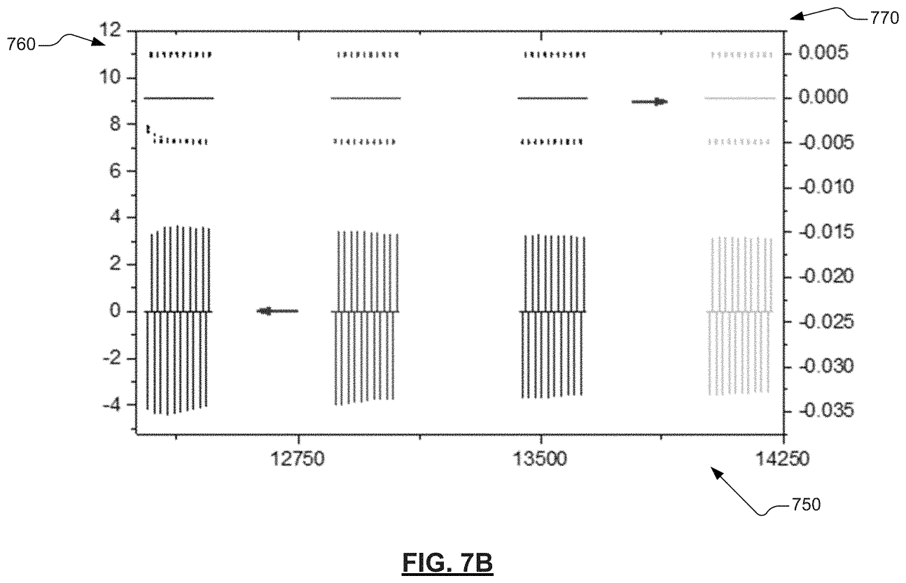

FIG. 7A is a graphical illustration demonstrating cycling date for the example electrode including the first and second ionically conductive polymer composite interlayer, where the x-axis 710 is the time (s), the y₁-axis 720 is the potential of the electrode (−Ewe/V), and the y₂-axis 730 is the current (<|>/mA), where each section on the graph represents 10 cycles. By way of comparison, FIG. 7B is a graphical illustration demonstrating cycling data for another example electrode having the same configuration as the example electrode illustrated in FIG. 6A, but omitting the first and second ionically conductive polymer composite interlayers where the x-axis 610 is the time (s), the y₁-axis 620 is the potential of the electrode (Ewe/V), and the y₂-axis 730 is the current (<|>/mA) , where each section on the graph represents 10 cycles. As illustrated, the example electrode including the ionically conductive polymer composite interlayers has improved cyclability and stability, for example, because the ionically conductive polymer composite interlayers prevent reaction between the electroactive material layers and the solid-state electrolyte layer. As illustrated, the example electrode including the ionically conductive polymer composite interlayers completes about 30 cycles, while the comparative electrode is unable to compete a single cycle.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for forming an ionically conductive polymer composite interlayer, the method comprising:
forming a precursor layer between a first surface of an electroactive material layer and a first surface of a solid-state electrolyte layer, wherein at least one of the electroactive material layer or solid-state electrolyte comprises lithium, the first surface of the electroactive material layer and the first surface of the solid-state electrolyte layer are substantially parallel, and the precursor layer comprises one or more fluoropolymers comprising carbon and fluorine; and
converting the precursor layer to the ionically conductive polymer composite interlayer, wherein the ionically conductive polymer composite layer has an ionic conductivity greater than or equal to about 1.0×10⁻⁸ S·cm⁻¹ to less than or equal to about 1.0 S·cm⁻¹ and comprises a lithium fluoride embedded in a carbonaceous matrix.

2. The method of claim 1, wherein converting the precursor layer to the ionically conductive polymer composite interlayer comprises applying pressure to the precursor layer.

3. The method of claim 2, wherein the electroactive material layer comprises lithium metal and the applied pressure is greater than a yield strength of the lithium metal.

4. The method of claim 2, wherein the applied pressure is greater than or equal to about 0.5 MPa and the pressure is applied for a period greater than or equal to about 1 minute to less than or equal to about 10 hours.

5. The method of claim 1, wherein converting the precursor layer to the ionically conductive polymer composite interlayer comprises applying heat to the precursor layer.

6. The method of claim 5, wherein the applied heat is greater than or equal to about 80° C. to less than or equal to about 180° C.

7. The method of claim 1, wherein the one or more fluoropolymers are selected from the group consisting of: polyvinylfluoride (PVF), polyvinylidene fluoride (PVDF), polytetrafluoroethylene (PTFE), polychlorotrifluoroethylene (PCTFE), perfluoroalkoxy polymer (PFA/MFA), fluorinated ethylene-propylene (FEP), polyethylenetetrafluoroethylene (ETFE), polyethylenechlorotrifluoroethylene (ECTFE), perfluorinated elastomer (FFPM/FFKM), tetrafluoroethylene-propylene (FEPM), perfluoropolyether (PEPE), perfluorosulfonic acid (PFSA), and combinations thereof.

8. The method of claim 1, wherein the precursor layer has a thickness of greater than or equal to about 5 nm to less than or equal to about 5 μm.

9. The method of claim 1, wherein the solid-state electrolyte layer is flexible, the solid-state electrolyte layer having a Young's modulus of less than or equal to about 20 GPa.

10. A method for forming an ionically conductive polymer composite interlayer, the method comprising:
disposing a precursor layer on or adjacent to a surface of an electroactive material layer, wherein the electroactive material layer comprises lithium metal and the precursor layer comprises one or more fluoropolymers comprising carbon and fluorine;
disposing a solid-state electrolyte layer on or adjacent to an exposed surface of the precursor layer; and
applying at least one of pressure and heat to the precursor layer so to form the ionically conductive polymer composite interlayer disposed between the solid electrolyte layer and the electroactive material layer, wherein the ionically conductive polymer composite layer has an ionic conductivity greater than or equal to about 1.0×10⁻⁸ S·cm⁻¹ to less than or equal to about 1.0 S·cm⁻¹ and comprises lithium fluoride embedded in a carbonaceous matrix.

11. The method of claim 10, wherein the applied pressure is greater than the yield strength of the lithium metal.

12. The method of claim 10, wherein the applied pressure is greater than or equal to about 0.5 MPa and the pressure is applied for a period of greater than or equal to about 1 minute to less than or equal to about 10 hours.

13. The method of claim 10, wherein the applied heat is greater than or equal to about 80° C. to less than or equal to about 180° C.

14. The method of claim 10, wherein the one or more fluoropolymers are selected from the group consisting of: polyvinylfluoride (PVF), polyvinylidene fluoride (PVDF), polytetrafluoroethylene (PTFE), polychlorotrifluoroethylene (PCTFE), perfluoroalkoxy polymer (PFA/MFA), fluorinated ethylene-propylene (FEP), polyethylenetetrafluoroethylene (ETFE), polyethylenechlorotrifluoroethylene (ECTFE), perfluorinated elastomer (FFPM/FFKM), tetrafluoroethylene-propylene (FEPM), perfluoropolyether (PEPE), perfluorosulfonic acid (PFSA), and combinations thereof, and
wherein the precursor layer has a thickness of greater than or equal to about 5 nm to less than or equal to about 5 μm.

15. The method of claim 10, wherein the solid-state electrolyte layer is flexible, the solid-state electrolyte layer having a Young's modulus of less than or equal to about 20 GPa.

16. A method for forming ionically conductive polymer composite interlayers, wherein the method comprises:
disposing a first precursor layer on or adjacent to a first surface of a solid-state electrolyte layer;
disposing a second precursor layer on or adjacent to a second surface of the solid-state electrolyte layer, wherein each of the first and second precursor layers comprises one or more fluoropolymers comprising carbon and fluorine;
disposing a first electroactive material layer on or adjacent to an exposed surface of the first precursor layer;
disposing a second electroactive material layer on or adjacent to an exposed surface of the second precursor layer; and
applying at least one of pressure and heat to the first and second precursor layers so as to form a first ionically conductive polymer composite interlayer between the solid-state electrolyte layer and the first electroactive material layer and a second ionically conductive polymer composite interlayer between the solid-state electrolyte and the second electroactive material layer, wherein the first and second ionically conductive polymer composite layers have ionic conductivities greater than or equal to about 1.0×10⁻⁸ S·cm⁻¹ to less than or equal to about 1.0 S·cm⁻¹ and each comprises lithium fluoride embedded in a carbonaceous matrix.

17. The method of claim 16, wherein each of the first and second electroactive material layers comprises lithium metal and the applied pressure is greater than a yield strength of the lithium metal.

18. The method of claim 16, wherein the applied heat is greater than or equal to about 80° C. to less than or equal to about 180° C.

19. The method of claim 16, wherein the one or more fluoropolymers are selected from the group consisting of: polyvinylfluoride (PVF), polyvinylidene fluoride (PVDF), polytetrafluoroethylene (PTFE), polychlorotrifluoroethylene (PCTFE), perfluoroalkoxy polymer (PFA/MFA), fluorinated ethylene-propylene (FEP), polyethylenetetrafluoroethyl ene (ETFE), polyethylenechlorotrifluoroethylene (ECTFE), perfluorinated elastomer (FFPM/FFKM), tetrafluoroethylene-propylene (FEPM), perfluoropolyether (PEPE), perfluorosulfonic acid (PSA), and combinations thereof, and
wherein each of the first and second precursor layers has a thickness of greater than or equal to about 5 nm to less than or equal to about 5 μm.

20. The method of claim 16, wherein the solid-state electrolyte layer is flexible, the solid-state electrolyte layer having a Young's modulus of less than or equal to about 20 GPa.
